(19) United States
(12) Patent Application Publication
(10) Pub. No.: US 2007/0271765 A1
(43) Pub. Date: Nov. 29, 2007

(54) Machining System for Cutting Cylinder Heads

(76) Inventors: Oliver Doerfel, Hochdorf (DE); Thomas Hornig, Notzingen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/576,891

(22) PCT Filed: Sep. 7, 2004
(86) PCT No.: PCT/EP04/09946

§ 371 Date: Feb. 5, 2007

(30) Foreign Application Priority Data
Oct. 24, 2003 (DE) 103 49 697.1

(51) Int. Cl. B23P 13/00

(52) U.S. Cl. 29/558

(57) ABSTRACT

A machining system for cutting cylinder heads (3) and comprises a plurality of machining stations, in which the cylinder heads (3) to be machined are machined in different orientations is provided. Each machining station comprises one or more identical machine tools (9). Each of these machine tools (9) has a plurality of tool spindles (7, 7′), at least some of which are equipped permanently with a tool (8, 8′). The cylinder head (3) is displaced in the working space (6) of the machine tool (9) with the aid of a displacement unit and is positioned with respect to the tools (8, 8′) in such a way that these tools (8, 8′) come into engagement with the cylinder head (3) in succession or simultaneously. By means of such a machining system, the idle times in the cutting of cylinder heads (3) can be reduced considerably.

The invention is for a machining system for cutting cylinder heads, in particular cylinder heads for passenger cars.

In order to cut cylinder heads, transfer lines are conventionally employed, consisting of a plurality of individual stations which are rigidly linked to one another. The cylinder head to be machined runs sequentially through these stations, each of the stations carrying out another machine step on the cylinder head. Such transfer lines are highly inflexible on account of the rigid succession of individual stations.

In order to increase the flexibility of the cylinder head machining system, some (or all) of these stations may be replaced by flexible machining centers. Each of these machining centers has one or more tool spindles and a tool changing , system, with the aid of which the spindles can be equipped with different tools. The sequential use of these tools on the spindle of the machining center makes it possible to carry out a large number of different machining operations on the cylinder head. While the machining centers allow high flexibility, their use entails high proportions of unproductive idle times (on account of the tool changes) which reduce the effectiveness of the production system.

The invention is based on the object of proposing a machining center for cylinder heads which, on the one hand, is highly flexible and, on the other hand, allows a considerable reduction in the machining times on cylinder heads.

The object is achieved, according to the invention, by means of the features of claim 1.

Accordingly, the flexible machining centers of the cylinder head machining system are replaced by machine tools, in the working space of which are located a plurality of driven spindles which are provided in each case with a tool. In contrast to the conventional machining centers, no tool change takes place on the spindles during machining, but, instead, each of the tools required is in a fixed mounting on an individual tool spindle assigned to the tool.

In contrast to the prior art of cylinder head machining in flexible machining centers, where the tool change on the spindles gives rise to a large proportion of unproductive idle time (as a rule, >60% in the machining of cylinder heads made from aluminium), in the machine tools used in the invention there is no tool change during machining, since each tool has its own spindle. The idle times in cylinder head machining can thereby be reduced considerably.

Advantageously, at least some of the spindles are arranged in the working space of the machine tool in such a way that the tools fastened on them can come into engagement simultaneously on the cylinder head. By virtue of this multiple-spindle machining, the main time in the machining of the cylinder heads can be greatly reduced.

Expediently, the machine tools are of flexible design, so that the tools and spindles can be arranged within the machine at various locations and with various orientations. The machine tools then have the same basic construction for different machining stations, but are provided with different spindles and tools, depending on the machining station. On account of the standard basic construction of the machines, maintenance is appreciably simplified. Furthermore, in the event of a machine failure, a replacement machine can quickly be configured and substituted. Finally, the machines can be re-configured easily and quickly when another type of cylinder head is to be machined.

The spindles which hold the tools may be mounted displaceably or pivotably in the machine tool, so that a plurality of machining steps can be carried out on the cylinder head with the aid of one and the same tool. Advantageously, however, all the axes of movement in the machine tools are concentrated in the cylinder head to be machined. This means that the spindles or tools are fixed permanently and immoveably in the machine tool; the relative movements which the cylinder head executes with respect to the tools of the machine tool during machining take place with the aid of a multiaxially moveable clamping device on which the cylinder head is mounted.

These machine tools are preferably employed at all the stations of the machining system. These stations differ from one another in respect of the angular orientation in which the cylinder heads are machined and have the cylinder heads running through them sequentially. Each station comprises one or more machine tools, on which the cylinder heads are cut. All the machine tools belonging to a predetermined station are equipped identically. The machine tools of different stations differ from one another in respect of their tool equipment, so that each of these machine tools have in each case only those tools which are required for machining the cylinder heads in the respective mounting corresponding to this station.

The cylinder head is fed to the machine tools with the aid of a transport system. In the machine tool, according to the respective station, the cylinder head is received in a predetermined orientation on a clamping head and is moved through the working space of the machine tool with the aid of a displacement unit.

The invention is explained in more detail below by means of an exemplary embodiment illustrated in the drawings in which:

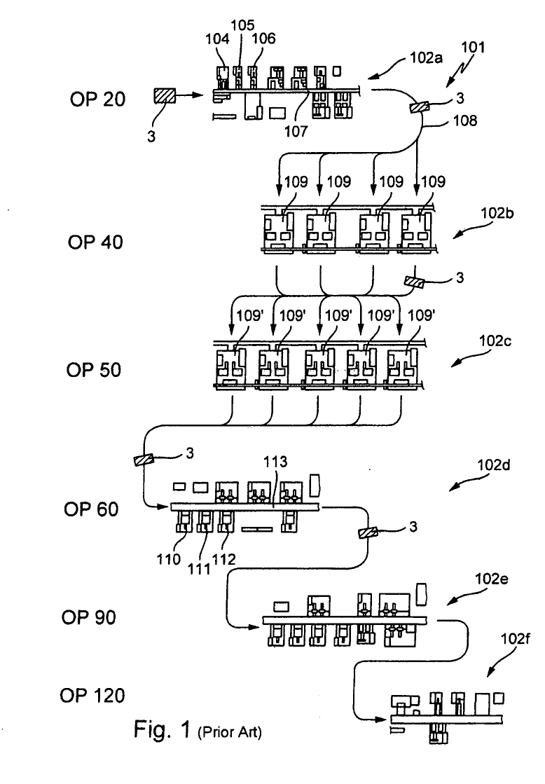

FIG. 1. shows a diagrammatic view of a machining system for cylinder heads according to the prior art;

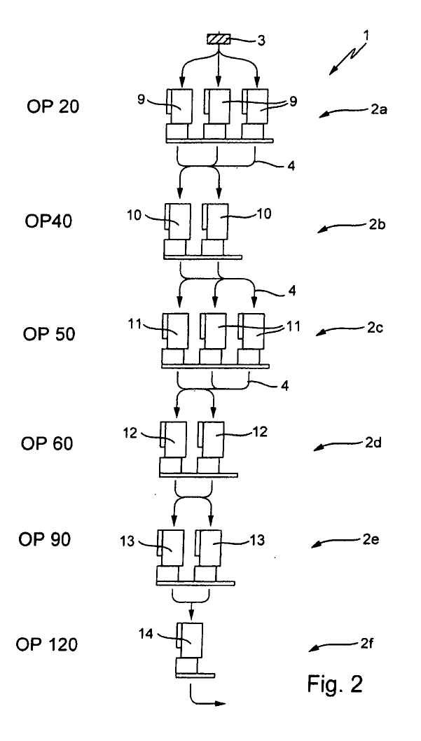

FIG. 2. shows a diagrammatic view of a machining system for cylinder heads according to the invention;

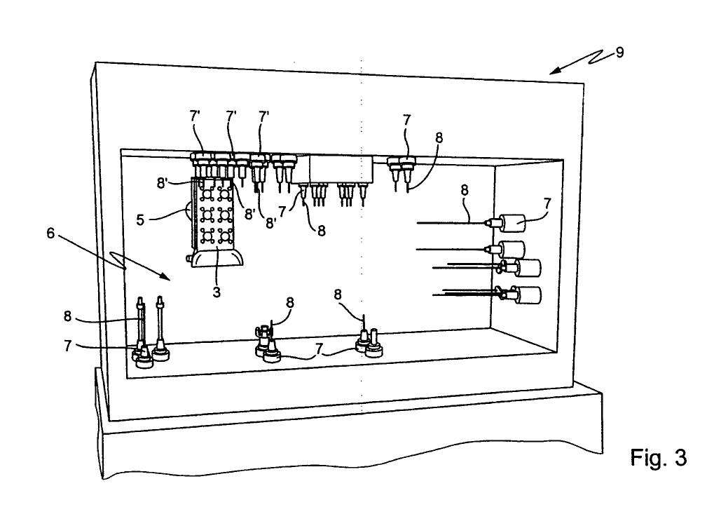

FIG. 3. shows a perspective view of a machine tool.

FIG. 1 shows a conventional machining system 101 for cutting cylinder heads for passenger cars. The system 101 comprises six machining stations 102a to 102f, through which cylinder heads run sequentially during cylinder head machining. In the different machining stations 102a to 102f, the cylinder heads are machined in different angular orientations (OP20, OP40, . . . ). The cylinder head blank 3 is first fed to the machining station 102a at commencement of machining. In this machining station 102a, different cuttings steps (milling operations, drilling operations, etc.) are carried out on the cylinder head blank 3 in the orientation OP20 with the aid of a plurality of machine tools 104a, 105a, 106a, etc. The cylinder head blank 3 is fed sequentially with the aid of a conveying device 107a to the machine tools 104a, 105a, 106a, each of which effects a different machining operation on the blank 3. Each of the machine tools 104a, 105a, 106a, etc. is thus tied down to a specific machining task (fixed cylinder head mounting, fixed machining tool).

After the termination of the machining steps of station 102a, the cylinder head blank 3 is fed to the next machining station 102b with the aid of a conveying device 108 (illustrated diagrammatically as an arrow). This machining station 102b comprises four identically equipped flexible machining centers 109, in which the cylinder head blank 3 undergoes cutting in orientation OP40. Each of these flexible machining centers 109 is equipped such that the entire machining program corresponding to the orientation OP40 can be executed in it; these flexible machining centers 109 are thus arranged parallel to one another, so that the cylinder head blank 3 in each case runs through only one of these flexible machining centers 109. Each of the flexible machining centers 109 is equipped with a spindle and with a tool magazine containing all the tools which are required for cylinder head machining in the orientation OP40. During cylinder head machining in the work cells 109, different tools are used, which are placed in succession from the tool magazine of the work cell 109 on to the spindle of this work cell 109.

After the termination of the machining steps of station 102b, the cylinder head blank 3 is transported into a machining station 102c, in which it is machined in the orientation OP50 with the aid of the flexible machining centers 109′. These flexible machining centers 109′, too, are arranged parallel to one another, so that each cylinder head blank 3 runs through only one of these flexible machining centers 109′. The machining centers 109′ differ from the flexible machining centers 109 of the machining station 102b only in respect of the mounting of the cylinder head and in respect of the tools which are stocked in the tool magazine.

The cylinder head blanks 3 are subsequently fed to the machining station 102d, in which they are machined in an orientation OP60. This machining station 102d resembles the station 102a in as much as it also comprises a plurality of machine tools 110, 111, 112 etc. through which the cylinder heads run sequentially; each cylinder head 3 is thus fed in succession with the aid of a conveying device 113 to all the machine tools 110, 111, 112, etc. and is machined there with the aid of a specific tool. This also applies similarly to the machining stations 102e and 102f, in which the cylinder head blanks 3 run sequentially in the orientations OP90 and OP120 through a plurality of machine tools. The cutting of the cylinder head 3 is thereafter terminated.

The conventional machining system 101 is thus a hybrid system with ridged components (transfer lines 102a, 102d, 102e, 102f) and flexible components (work cells 109, 109′ in stations 102b and 102c).

A machining system 1 according to the invention for cutting cylinder heads 3 is illustrated in FIG. 2. Here, too, cylinder head machining takes place in six machining stations 2a to 2f, each of these machining stations corresponding in each case to a defined angular orientation (OP20, OP40, . . . ) of the cylinder head 3. In the machining station 2a through which cylinder heads run first, three machine tools 9, which are configured and equipped identically, are provided for cutting the cylinder head 3 in the orientation OP20. The cylinder head 3 to be machined is fed, according to availability, to one of these three machine tools 9 and is machined there.

FIG. 3 shows a perspective view of the machine tool 9. The machine 9 comprises a clamping device 5, with the aid of which the cylinder head 3 is received in orientation OP20. The clamping device 5 is mounted on a displacement unit (not illustrated in FIG. 3), with the aid of which the cylinder head can be displaced in the working space 6 of the machine tool 9. Furthermore, the machine tool 9 comprises a multiplicity of fixed spindles 7, in which tools 8 (drills, milling cutters, . . . ) are received. These tools 8 thus project into the working space 6 of the machine tool 9 from below, from above and laterally. The spindles 7 can be driven individually, but may also be coupled; some of them are arranged in the working space 6 of the machine tool 9 in such a way that a plurality of machining operations can be carried out simultaneously on the cylinder head 3 with the aid of tools 8 guided on said spindles. Thus, for example, after the cylinder head 3 has been positioned with high accuracy in relation to the spindles 7′ with the aid of the displacement unit, a plurality of drilling operations can be carried out simultaneously on the cylinder head 3 with the aid of the tools 8′ held in said spindles.

In contrast to the machine tools 109 of the machining stations 102b and 102c of the conventional machining system 101, in which the spindles for machining the cylinder head 3 are equipped in succession with different tools which they extract from the tool magazine, each spindle 7, 7′ in the machine tool 9 carries a fixed tool 8, 8′. Whereas major (unproductive) idle times occur in the machine tools 109 due to the tool change, the machine tools 9 are virtually free of idle time. A further time saving arises in that a plurality of tools 8, 8′ can come into engagement simultaneously with the cylinder head 3.

When the machining of the cylinder head 3 is concluded in one of the machine tools 9 of the station 2a, the cylinder head 3 is introduced with the aid of a conveying system 4 into one of the machine tools 10 of the machining station 2b, where the cylinder head 3 is machined in the orientation OP40. The machine tools 10 correspond in respect of their basic construction to the machine tools 9, but they have another set of spindles and tools which are arranged in the working space of the machine tool 10 such that all the machining steps in the orientation OP40 of the cylinder head 3 can be carried out with the aid of the tools held in these spindles. After the machining of the cylinder head 3 in one of the machine tools 10 of the station 2b, the cylinder head 3 is introduced into one of the machine tools 11 of the station 2c, in which it is machined in the orientation OP50. This is followed by machinings in station 2d (in one of the machines 12), station 2e (in one of the machines 13) and station 2f (in machine 14). Each of these machine types 11,12,13,14 corresponds in respect of their basic construction to the machines 9 and 10 and has a set of spindles and of tools which are held fixedly in these spindles and are required for machining the cylinder head in the associated orientation.

The number of machine tools 9, 10 . . . in the machining stations 2a to 2f corresponds to the machining times of the cylinder heads 3 in the associated orientation OP20, OP40, . . . Thus, for example, more (to be precise three) machine tools 9, 11 are provided in the stations 2a and 2c, for example, in which a comprehensive machining program is executed on the cylinder heads 3, than in the remaining stations. By the number of machine tools 9, 10, . . . in the stations 2a, 2b, . . . being adapted, the runthrough times of the cylinder heads 3 through the machining system 1 can be optimized.

As described above, the machine tools 9, 10, . . . are identical in respect of their basic construction, but differ in respect of their equipment, that is to say in respect of the position and orientation of the spindles 7, 7′ and of the tools 8, 8′ held in the spindles 7, 7′. As a result, for example, machine tools 9 in station 2a can be converted into machine tools 10 in station 2b, in that the machine tool 9 is provided with other spindles which in turn are equipped with other tools.

1-4. (canceled)

5. A machining system for cutting cylinder heads comprising:
a plurality of machining stations, the cylinder heads to be machined being machined in different orientations in the plurality of machining stations;
the cylinder heads to be machined being fed sequentially to the machining stations;
at least one of the machining stations including a plurality of identical machine tools;
each machine tool including a plurality of tool spindles, at least some of the tool spindles being equipped permanently with a tool; and
the at least some of the tool spindles being arranged in a working space of the machine tool so that the machine tools fastened on them come into engagement simultaneously on the cylinder head.

6. The machining system as claimed in claim 5 wherein the machine tools of different machining stations are identical in respect of their basic construction, but differ from one another in respect of the number and/or arrangement and/or dimensioning of the tool spindles contained in them.

7. The machining system as claimed in claim 5 wherein the tool spindles are fixed immoveably in the machine tools, so that all the relative movements of the cylinder head in respect of the tools are effected with the aid of a clamping device.

8. The machining system as claimed in claim 5 wherein the machine is a motor vehicle cylinder head cutting machine.
